(19) United States
(12) Patent Application Publication
(10) Pub. No.: US 2006/0186371 A1
(43) Pub. Date: Aug. 24, 2006

(54) Heat exchange fluid with coloring agent

(76) Inventor: Roy Perlove, Brighton, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/358,159

(22) Filed: Feb. 21, 2006

Related U.S. Application Data
(60) Provisional application No. 60/655,109, filed on Feb. 22, 2005.

(51) Int. Cl. C09K 5/00

(52) U.S. Cl. 252/71

(57) ABSTRACT

A heat transfer fluid, such as an antifreeze composition, is colored with a dye which may be one or more of Acid Yellow 5 and Acid Yellow 3. The composition may further include other dyes.

### RELATED APPLICATION

This application claims priority of U.S. Provisional Patent Application Ser. No. 60/655,109 filed Feb. 22, 2005, entitled “Heat Exchange Fluid with Coloring Agent.”

### FIELD OF THE INVENTION

This invention relates generally to heat exchange fluids such as antifreeze compositions used in the cooling systems of motor vehicles. More specifically, the invention relates to heat exchange fluids which include a coloring agent. Most specifically, the invention relates to heat exchange fluids which include Acid Yellow 5 or Acid Yellow 3 therein.

### BACKGROUND OF THE INVENTION

Heat exchange fluids, also referred to antifreeze compositions, are utilized in the coolant systems of motor vehicles. Compositions of this type generally include a fluid component having a high boiling point and a low freezing point, and generally further include water as well as ancillary ingredients such as corrosion inhibitors, lubricants and the like. Such heat exchange fluids are also utilized in chemical and food processing equipment for heating or cooling purposes as well as in heating and cooling systems of building structures.

Heat transfer fluids generally include a coloring agent therein. The agent functions to impart a strong and distinctive color to the fluid so that system leaks may be readily visualized and so that the fluid may be distinguished from other liquids such as water and the like.

Coloring agents used in connection with heat transfer fluids must be compatible with the components of the fluid as well as with the mechanical system in which the fluid is employed. As such, the coloring agent should be chemically stable and not prone to the formation of precipitates or the like. Also, it should not be corrosive toward components of the mechanical system. In addition, it is generally preferred that it be very highly colored so that relatively small amounts of the agent are incorporated into the fluid.

The prior art describes various heat transfer fluids including dye compositions therein. For example, U.S. Pat. No. 6,818,174 suggests the use of the dye Reactive Violet 5 for coloring antifreeze compositions based upon alkylene glycols. This patent further describes experiments carried out using a large number of other dyes for this purpose, and concluded that problems of residue formation and the like were attendant upon the use of such other dyes. U.S. Pat. No. 5,723,060 describes the use of certain dyes selected from the family referred to as Reactive Blue for the coloring of antifreeze compositions. Both of these patents describe a variety of antifreeze compositions based upon alkylene glycols together with ancillary ingredients such as corrosion inhibitors, lubricants and the like. The disclosures of these patents are incorporated herein by reference.

As will be described hereinbelow, in accord with the principles of the present invention, it has been found that particular dyes comprising Acid Yellow 5 and Acid Yellow 3 are particularly advantageous as coloring agents for glycol-based antifreeze compositions. These dyes may be used alone or in combination with other appropriate dyes, provide a high degree of coloring, and are stable and compatible with antifreeze compositions and engine components. These and other advantages of the invention will be apparent from the discussion and description which follow.

### BRIEF DESCRIPTION OF THE INVENTION

Disclosed herein is a heat transfer composition which comprises a polyhydric alcohol together with a dye component which is one or more of Acid Yellow 5 and Acid Yellow 3. The first dye component may be present in an amount ranging from 1 part per million up to 2% by weight with regard to the polyhydric alcohol. In specific instances, the polyhydric alcohol may be an alkylene glycol, and a specific group of alkylene glycols comprise the C₂-C₆ alkylene glycols, with ethylene glycol and propylene glycol being representative members of that group. The composition of the present invention may further include typical ancillary ingredients found in antifreeze compositions such as corrosion inhibitors, lubricants, leak sealants, defoaming agents, and the like. The compositions of the present invention may be prepared as concentrates which are typically diluted with water for subsequent use, or they may be provided as ready to use aqueous solutions.

In some instances, the compositions of the present invention may include a second dye component, and in particular instances, the second dye component is one or more Red Xanthene dye. Acid Rhodamine and Acid Red 52 are some Red Xanthene dyes which may be utilized in this invention.

Also disclosed is a dye concentrate for coloring antifreeze compositions. The concentrate is based upon Acid Yellow 5 and/or Acid Yellow 3, and further includes solvents such as diethylene glycol and water. In some instances, the concentrate may include further ingredients such as urea and may also include further dye materials such as the foregoing Red Xanthene dyes.

Also disclosed herein is a method for preparing a heat transfer fluid which comprises mixing the foregoing dye compositions with a polyhydric alcohol, and ancillary ingredients such as corrosion inhibitors and the like.

### DETAILED DESCRIPTION OF THE INVENTION

In accord with the present invention, it has been found that the dye Acid Yellow 5, which is registered under C.A.S. Number 1324-04-5, and which has the structure represented by Formula I hereinbelow, is a very effective coloring agent for use in heat transfer fluids of the type which are based upon polyhydric alcohols. As will be seen from the formula, the location of the sulfonate groups is somewhat variable in this material. Also, while the formula shows the sodium salt, other salts may likewise be employed, and all of such materials are deemed to be Acid Yellow 5.

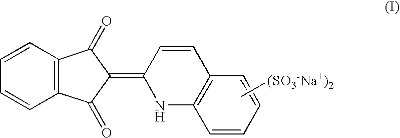

Acid Yellow 3 is chemically very similar to Acid Yellow 5, and may be used in conjunction with, or substituted therefor, in the foregoing compositions of the present invention. The formula of Acid Yellow 3 is shown below at Formula II:

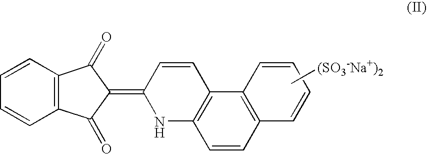

Yet other dyes representing minor chemical modifications of the foregoing, such as alkylated, halogenated, and otherwise substituted variants thereof may likewise be employed in the practice of the present invention. Accordingly, it is to be understood that numerous modifications of the invention may implemented in accord with the teaching presented herein.

Heat transfer fluids of the present invention broadly comprise a polyhydric alcohol, water and the aforementioned dye. Generally, the polyhydric alcohols employed in the fluids are alkylene glycols, and in particular C₂-C₆ alkylene glycols. In specific instances, the polyhydric alcohols comprise ethylene glycol, propylene glycol, and combinations of the two. As is known in the art, heat transfer fluids will generally include a corrosion inhibitor which functions to protect the metal components of systems in which the fluid is disposed. There are a wide variety of corrosion inhibitors known to those of skill in the art, and specific inhibitors may be readily selected depending upon particular applications. Such corrosion inhibitors include alkali metal compounds such as phosphates, silicates, borates and the like as well as various organic acids, amines, and the like as well organic materials such as polyacrylates, organic acids, thiazoles, triazoles, and so forth.

The amount of dye utilized in the composition will depend upon the specific application, and the degree of coloration which is necessary. In some instances, the dye may be present in amounts as low as one part per million, by weight, on the basis of the polyhydric alcohol; while in other instances, the compositions may include as much as 2% by weight of the dye, based upon the polyhydric alcohol component. In typical glycol-based fluids used as antifreeze compositions for motor vehicles, the dye will be present in an amount of 1-800 ppm by weight. In various other applications, the foregoing ranges may be varied.

Compositions of the present invention may also include dyes other than the aforementioned Acid Yellow 5 and Acid Yellow 3. Such further dyes may aid in adjusting the final composition of the heat transfer fluid. One group of dyes having utility for this purpose are the dyes generically referred to as the Red Xanthene dyes. These dyes have good solubility in water and polyhydric solvents, and are generally stable in heat transfer fluid applications. One specific Red Xanthene dye which has utility as an adjunct in the present invention is acid rhodamine and another is Acid Red 52. Other dyes, including Red Xanthene dye and non-Red Xanthene dyes, may also have utility in the present invention, and one of skill in the art, in view of the teaching presented herein, could readily select such dyes. The concentration of the ancillary dye will depend upon the nature of the dye itself as well as the desired final color of the composition. Typically, the ancillary dyes will be used in a weight concentration, based upon the polyhydric alcohol component, at a range of 1 part per million to 2%.

In accord with the present invention, heat transfer fluid compositions may be prepared by blending one or more of the aforementioned dye components with ethylene glycol, propylene glycol, or any other polyhydric alcohol component of the fluid. Water may be included in the mixture, as may be ancillary ingredients such as corrosion inhibitors, sealants, defoamers, lubricants and the like. In some instances, the heat transfer fluid may be prepared as a concentrate which includes relatively low, or no, amounts of water. This concentrate may subsequently be diluted with water for use. In other instances, a heat transfer fluid may be prepared including both water and a polyhydric alcohol. In either instance, the dyes of the present invention may be readily included in the compositions.

In some instances, the present invention may be utilized to formulate a dye concentrate for use in preparation of a heat transfer fluid. In such instance, the composition of the present invention will be formulated as a relatively high concentration solution of dye dissolved in an appropriate solvent mixture which is compatible with the heat transfer fluid composition. The concentrate may include stabilizers and the like. In one specific instance, the concentrate comprises a water based solution of Acid Yellow 5, and may further include minor amounts of other protic solvents such as diethylene glycol. This solution may optionally include a red xanthene dye. In another instance, similar concentrates may be formulated, based upon Acid Yellow 3. Such concentrates provide a stable, easy to handle solution which may be readily incorporated into an antifreeze composition by mixing. In view of this teaching, other concentrate formulations will be readily apparent to those of skill in the art.

Heat transfer fluids prepared in accord with the present invention produce a bright colored solution which is stable in use. Accelerated aging tests duplicating use conditions showed that the compositions of the present invention retain their initial color, while a similar composition based upon the dye Acid Green 25 lost 60-70% of its color. The compositions of the present invention are compatible with metals such as steel, brass, aluminum, copper and lead typically found in the cooling systems of motor vehicles. The compositions do not degrade metal or rubber, and are likewise not themselves degraded by use.

In view of the teaching presented herein, it is to be understood that numerous modifications and variations of the present invention will be readily apparent to those of skill in the art. For example, while the invention has primarily been described with reference to heat transfer fluid based upon polyhydric alcohols, the materials of the present invention may likewise be used in combination with fluids based upon monohydric alcohols, including primary, secondary and tertiary alcohols. Likewise, the compositions may be used in fluids based upon glycol ethers, polyols, esters and the like. The foregoing is illustrative of specific embodiments of the invention, but is not meant to be a limitation upon the practice thereof. It is the following claims, including all equivalents, which define the scope of the invention.

1. A heat transfer composition comprising:
a polyhydric alcohol; and
a first dye component comprising one or more of Acid Yellow 5 and Acid Yellow 3.

2. The composition of claim 1, wherein said first dye component is present in an amount ranging from 1 ppm to 2% by weight with regard to the polyhydric alcohol.

3. The composition of claim 1, wherein said polyhydric alcohol comprises an alkylene glycol.

4. The composition of claim 3, wherein said alkylene glycol is a C₂-C₆ alkylene glycol.

5. The composition of claim 3, wherein said alkylene glycol is selected from the group consisting of ethylene glycol, propylene glycol, and combinations thereof.

6. The composition of claim 1, wherein said composition further includes a corrosion inhibitor.

7. The composition of claims 1, wherein said composition further includes water.

8. The composition of claim 1, further comprising a second dye component comprising one or more Red Xanthene dyes.

9. The composition of claim 8, wherein said Red Xanthene dye comprises one or more of Acid Rhodamine and Acid Red 52.

10. The composition of claim 8, wherein said second dye component is present in an amount ranging from 1 ppm to 2% by weight with regard to said polyhydric alcohol.

11. A method of preparing a heat transfer fluid, said method comprising the steps of:
providing a polyhydric alcohol;
providing a dye component, said dye component comprising one or more of Acid Yellow 5 and Acid Yellow 3;
mixing said first dye component with said polyhydric alcohol;
providing a corrosion inhibitor; and
mixing said corrosion inhibitor with said polyhydric alcohol.

12. The method of claim 11, wherein said dye component further includes a Red Xanthene dye.

13. The method of claim 12, wherein said Red Xanthene dye comprises one or more of Acid Rhodamine and Acid Red 52.

14. A heat transfer composition comprising:
an alkylene glycol;
a corrosion inhibitor;
a first dye component comprising one or more of Acid Yellow 5 and Acid Yellow 3;
optionally, a second dye component comprising a Red Xanthene dye; and
optionally, water.

15. The composition of claim 14, wherein said Red Xanthene dye comprises one or more of Acid Rhodamine and Acid Red 52.

16. The composition of claim 14, wherein said alkylene glycol is a C₂-C₆ alkylene glycol.

17. The composition of claim 14, wherein said alkylene glycol comprises, on a weight basis, at least 50% of said composition, and the concentration of said first dye component and said optional second dye component is in the range of 1 ppm to 2% by weight, with regard to said polyhydric alcohol.
